(19) United States
(12) Patent Application Publication
(10) Pub. No.: US 2010/0044180 A1
(43) Pub. Date: Feb. 25, 2010

(54) HUB ASSEMBLY FOR A BICYCLE

(75) Inventor: Hubert CHEN, Taichung Hsien (TW)

Correspondence Address: FOLEY AND LARDNER LLP;SUITE 500, 3000 K STREET NW, WASHINGTON, DC, 20007, US

(73) Assignee: KUN TENG INDUSTRY CO., LTD.

(21) Appl. No.: 12/335,942

(22) Filed: Dec. 16, 2008

(30) Foreign Application Priority Data
Aug. 25, 2008 (TW) 097215248

(51) Int. Cl. F16D 41/30

(52) U.S. Cl. 192/64

(57) ABSTRACT

A hub assembly for a bicycle includes a hub shell adapted to be rotatably mounted on a hub axle and having angularly displaced retreat bores for receiving pawls, respectively. An annular drive member is rotatably mounted on the hub axle and is rotated with a flywheel mounting cylinder. A circumferential surface of the drive member has a plurality of cavities confronting the retreat bores. Each cavity has first and second engaging walls which are mirror images of each other such that, when the drive member is rotated in one of clockwise and counterclockwise directions, coupling ends of the pawls are respectively engaged with the first or second engaging walls to drive rotation of the hub shell, and such that, when the drive member is rotated in the other one of the clockwise and counterclockwise directions, the coupling ends are disengaged from the first or second engaging walls to be placed in an idle position.

### CROSS-REFERENCE TO RELATED APPLICATION

This application claims priority of Taiwanese Application No. 097215248, filed on Aug. 25, 2008.

### BACKGROUND OF THE INVENTION

1. Field of the Invention

This invention relates to a hub assembly for a bicycle, more particularly to a hub assembly which is suitable for use in left-drive and right-drive bicycles.

2. Description of the Related Art

Referring to FIGS. 1 and 2, a conventional hub assembly disclosed in U.S. Pat. No. 7,121,394 B2 includes a hub shell 2 rotatably mounted on a hub axle 1, a uni-directional mechanism 3 disposed within the hub shell 2, and a flywheel mounting cylinder 4 coupled to the hub shell 2 by means of the uni-directional mechanism 3. The hub shell 2 has a tubular wall 201 and a plurality of retreat bores 202 that extend axially from an inner surrounding surface of the tubular wall 201 and that are spaced apart from one another. Each retreat bore 202 includes two retaining regions 204,205 and a middle region 203 therebetween. The uni-directional mechanism 3 includes an annular drive member 301 which is rotated with the flywheel mounting cylinder 4 and which has an outer surrounding toothed surface, a plurality of pawls 302 which are respectively received in the retaining regions 204 of the retreat bores 202, and a plurality of leaf springs 303 which are respectively received in the retaining regions 205 to bias the pawls 302 to engage the outer surrounding toothed surface for driving the hub shell 2 to rotate in a uni-direction.

However, such hub assembly is adapted to be assembled to a right-drive bicycle, i.e., a sprocket and chainwheel assembly is disposed on the right side of the bicycle. In other words, the uni-directional mechanism 3 can be mounted only on a right side of the hub shell 2. Hence, it is necessary to provide a uni-directional mechanism specifically for a bicycle with a sprocket and chainwheel assembly disposed on the left side of a bicycle, which results in higher manufacturing and storage costs.

### SUMMARY OF THE INVENTION

An object of the present invention is to provide a hub assembly for a bicycle which is suitable for use in left-drive and right-drive bicycles.

According to this invention, the hub assembly includes a hub shell which is adapted to be mounted on and to be rotatable relative to a hub axle about an axis. The hub shell has an inner tubular wall surface which is spaced apart from the hub axle so as to define an annular accommodation space therebetween, and which has a plurality of retreat bores angularly displaced from one another about the axis. Each of the retreat bores includes first and second retaining regions opposite to each other in a circumferential direction, and a middle region interposed therebetween. A spoke-mounting member extends outwardly and radially from the inner tubular wall surface, and has a plurality of access openings extending axially to be communicated with the retreat bores, respectively. A plurality of pawls have coupling ends extending into the annular accommodation space. Each pawl further has a pivotable end which is insertable into one of the first and second retaining regions from the corresponding access opening and which is pivotable relative to the one of the first and second retaining regions so as to permit the coupling end to be moved between a driven position, where the coupling end extends radially into the annular accommodation space, and an idle position, where the coupling end retreats into the middle region. Each pawl further has an intermediate segment which has urged and trailing lateral sides respectively confronting the other one of the first and second retaining regions and the annular accommodation space. A flywheel mounting cylinder is rotatably mounted on the hub axle, and has a tubular coupling wall confronting the spoke-mounting member. An annular drive member is rotated with the tubular coupling wall, and has a circumferential surface which confronts the inner tubular wall surface radially, and which has a plurality of cavities angularly displaced from one another about the axis. Each cavity extends towards the axis to form first and second engaging walls which are spaced apart from each other in a circumferential direction about the axis, and which respectively cooperate with the circumferential surface to form first and second force effecting edges. When the annular drive member is rotated about the axis, the coupling end is engaged with one of the first and second engaging walls to place the coupling end in the driven position. When the coupling end is in the idle position, the trailing lateral side is pushed by pressing forces of the first force effecting edges or the second force effecting edges of the cavities to permit disengagement of the coupling end from the one of the first and second engaging walls for retreating the coupling end into the middle region. Each of a plurality of biasing members is disposed in the other one of the first and second retaining regions, and is configured to bias the urged lateral side so as to ensure the engagement of the coupling end with the one of the first and second engaging walls in the driven position. The first and second retaining regions of each retreat bore is configured such that, when the annular drive member is rotated in the clockwise or counterclockwise direction in the driven position, each biasing member is trailing behind the corresponding pawl.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a partly sectional view of a conventional hub assembly for a bicycle disclosed in U.S. Pat. No. 7,121,394 B2;

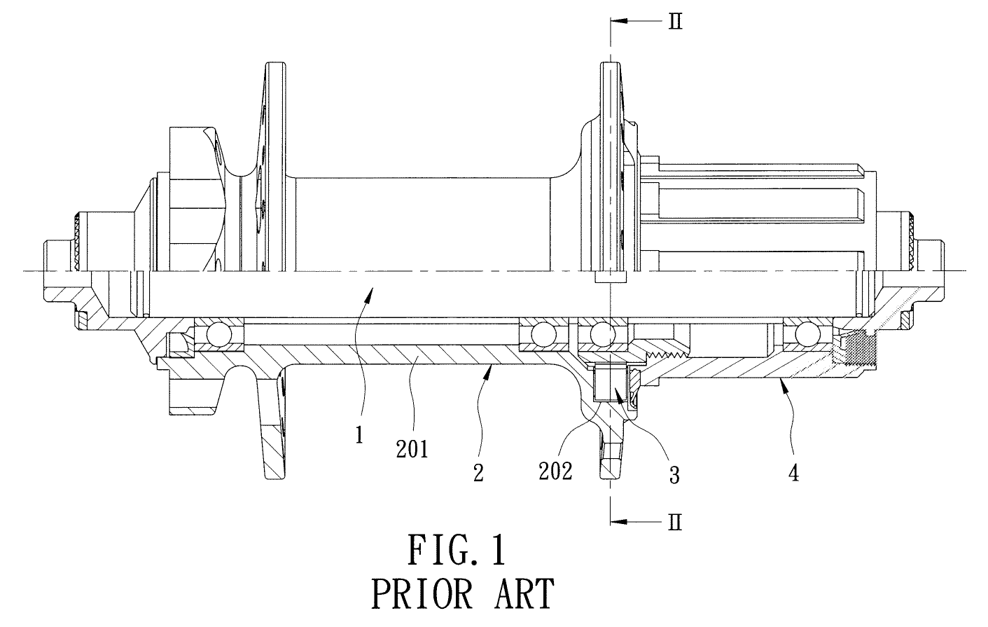

FIG. 2 is a cross-sectional view taken along lines II-II of FIG. 1;

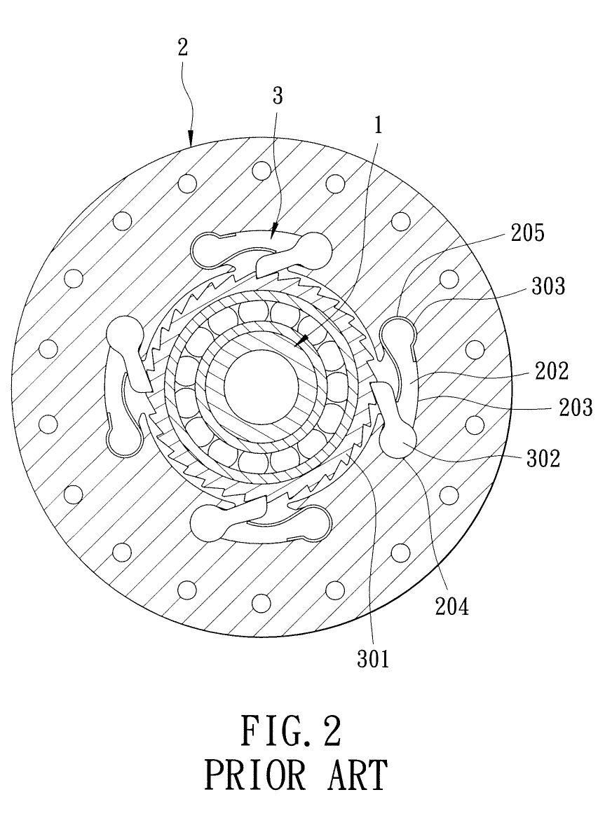

FIG. 3 is a partly sectional view of the preferred embodiment of a hub assembly for a bicycle according to this invention;

FIG. 4 is a cross-sectional view taken along lines IV-IV of FIG. 3;

FIG. 5 is a partly sectional view showing a flywheel mounting cylinder of the preferred embodiment when mounted on the left side of a bicycle; and

FIG. 6 is a cross-sectional view taken along lines VI-VI of FIG. 5.

### DETAILED DESCRIPTION OF THE PREFERRED EMBODIMENT

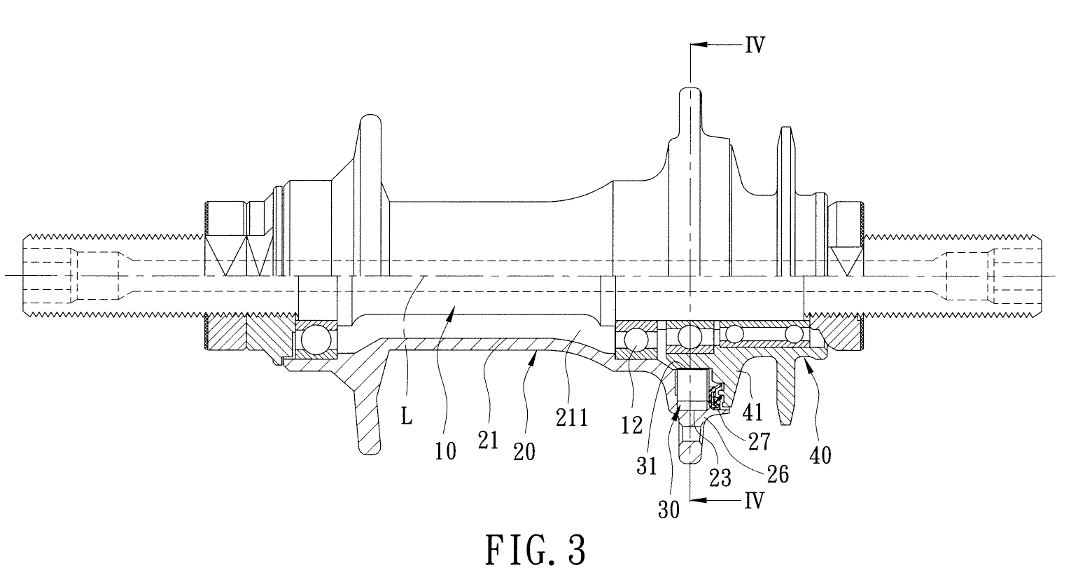

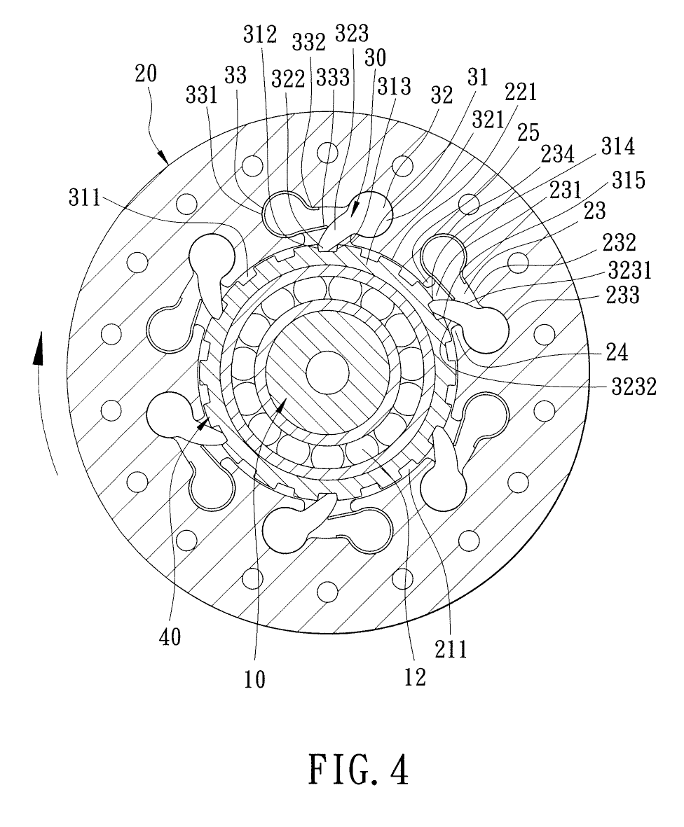

Referring to FIGS. 3 and 4, the preferred embodiment of a hub assembly according to the present invention is illustrated to be incorporated in a right-drive of bicycle. Referring to FIGS. 3 and 4, the hub assembly of this embodiment is shown to comprise a hub shell 20 which is adapted to be mounted on and to be rotatable relative to a hub axle 10 of the bicycle about an axis (L) by means of bearings 12, and which has an inner tubular wall surface 21 that is spaced apart from the hub axle 10 so as to define an annular accommodation space 211 therebetween, that extends along the axis (L), and that terminates at an inner periphery. As shown in FIGS. 3 and 4, the inner periphery is at the right side of the hub shell 20. The inner tubular wall surface 21 has a plurality of retreat bores 23 which are disposed proximate to the inner periphery, which are angularly displaced from one another about the axis (L), and which respectively extend outwardly and radially. A spoke-mounting member 26 extends from the inner periphery outwardly and radially, and has a plurality of access openings 27 which are angularly displaced from one another around the axis (L) and which extend axially to be communicated with the retreat bores 23, respectively. Each of the retreat bores 23 includes first and second retaining regions 233,234 which are disposed opposite to and which are mirror images of each other in a circumferential direction, and a middle region 232 interposed therebetween. The first and second retaining regions 233,234 are shaped to be symmetrical to each other. In addition, the inner tubular wall surface 21 has a plurality of first barrier portions 24 disposed adjacent to the first retaining regions 233, respectively, and a plurality of second barrier portions 25 disposed adjacent to the second retaining regions 234, respectively.

A flywheel mounting cylinder 40 is rotatably mounted on the hub axle 10 at the right side of the hub shell 20, and has a tubular coupling wall 41 that confronts the spoke-mounting member 26.

A uni-directional mechanism 30 includes a plurality of pawls 32, an annular drive member 31, and a plurality of biasing members 33.

Each of the pawls 32 includes a coupling end 322 which extends into the annular accommodation space 211, and a pivotable end 321 which is opposite to the coupling end 322 and which is insertable into the first retaining region 233 from the corresponding access opening 27 and which is pivotable relative to the first retaining region 233 so as to permit the coupling end 322 to be moved between a driven position, as shown in FIG. 4, where the coupling end 322 extends radially into the annular accommodation space 211, and an idle position, where the coupling end 322 retreats radially into the middle region 232. Each of the pawls 32 further includes an intermediate segment 323 which is interposed between the pivotable and coupling ends 321,322, and which has urged and trailing lateral sides 3231,3232 that are opposite to each other, and that respectively confront the second retaining region 234 and the annular accommodation space 211.

The annular drive member 31 is integrally formed with the tubular coupling wall 41 so as to be rotated with the flywheel mounting cylinder 40. The annular drive member 31 has a circumferential surface which confronts the inner tubular wall surface 21 radially, and which has a plurality of cavities 311 angularly displaced from one another about the axis (L). Each of the cavities 311 is configured to extend towards the axis (L) to form first and second engaging walls 312,313 which are spaced apart from each other in a circumferential direction about the axis (L), and which cooperate with the circumferential surface to respectively form first and second force effecting edges 314,315. Each of the cavities 311 is of a rectangular shape, and the first and second engaging walls 312,313 are mirror images of each other. Thus, when the annular drive member 31 is rotated about the axis, i.e., in a clockwise direction as shown in FIG. 4, the coupling end 322 is engaged with the first engaging wall 312 while the trailing lateral side 3232 is in slidable contact with the second force effecting edge 315 to place the coupling end 322 in the driven position. When the annular drive member 31 is rotated in a counterclockwise direction, the coupling end 322 is in the idle position, the trailing lateral side 3232 is pushed by pressing forces of the second force effecting edges 315 of the cavities 311 in turn, thereby permitting disengagement of the coupling end 322 from the first engaging wall 312 for retreating the coupling end 322 into the middle region 232.

Each of the biasing members 33 is a leaf spring which includes a bending portion 331 that is retained in the respective second retaining region 234, and first and second biasing end portions 332,333 that extend from the bending portion 331 towards the middle region 232, and that are spaced apart from each other in a radial direction relative to the axis (L) so as to enable the second biasing end portion 333 to urge the urged lateral side 3231 of the corresponding pawl 32 to permit the trailing lateral side 3232 to abut against the second force effecting edge 315 for ensuring the engagement of the coupling end 322 with the first engaging wall 312 in the driven position, and to bias the urged lateral side 3231 against the pressing forces for keeping the trailing lateral side 3232 in slidable contact with the corresponding second force effecting edge 315 in the idle position.

Moreover, each of the first barrier portions 24 is disposed to engage the trailing lateral side 3232 of the corresponding pawl 32 proximate to the pivotable end 321 so as to enable the urged lateral side 3231 to counteract against the biasing force of the second biasing end portion 333 for ensuring the engagement of the coupling end 322 with the first engaging wall 312 in the driven position. Furthermore, each of the second barrier portions 25 is disposed to adjust the biasing force of the second biasing end portion 333 of the corresponding biasing member 33, and to prevent removal of the bending portion 331 from the second retaining region 234.

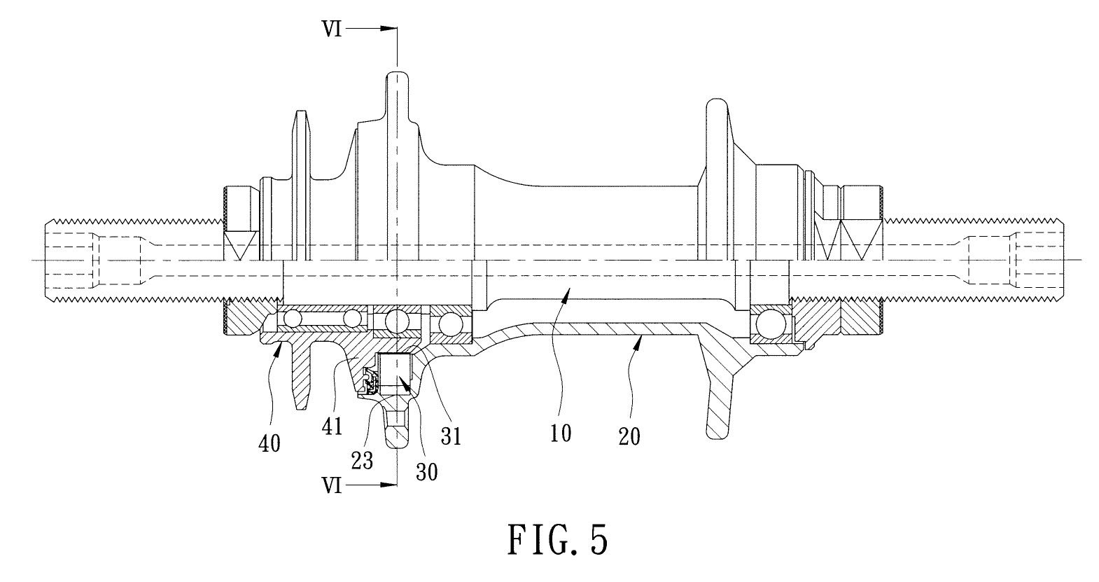

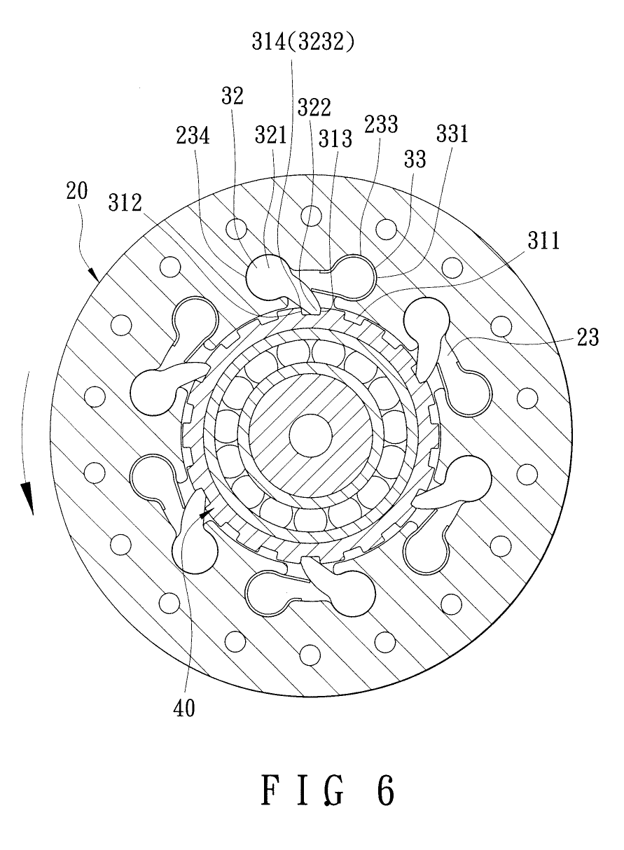

Referring to FIGS. 5 and 6, the preferred embodiment of the hub assembly according to this invention is illustrated to be incorporated in a left-drive of bicycle with a sprocket and chainwheel assembly (not shown) mounted on the left side of the bicycle. As shown, the hub shell 20 is mounted on the hub axle 10 with the retreat bores 23 located at the left side of the hub axle 10 such that the flywheel mounting cylinder 40 is disposed at the left side the hub shell 20. In addition, the pivotable end 321 of each pawl 32 is inserted into the second retaining region 234, and the bending portion 331 of the corresponding biasing member 33 is retained in the first retaining region 233. Thus, when the annular drive member 31 is rotated in a counterclockwise direction, the coupling end 322 of each pawl 32 is engaged with the second engaging wall 312 while the trailing lateral side 3232 is in slidable contact with the first force effecting edge 314 to thereby place the coupling end 322 in the driven position.

According to this invention, since each of the cavities 311 in the annular drive member 31 is of a rectangular shape, and since the first and second engaging walls 312,313 are mirror images of each other, the hub assembly of this invention is suitable for both left-drive and right-drive bicycles by reversing the direction of the hub shell 20 with respect to the hub axle 10 and by exchanging the positions of the pawl 32 and the biasing member 33 in each retreat bore 23. Specifically, when it is desired to use the hub assembly on a left-drive bicycle instead of a right-drive bicycle, after detaching the hub shell 20 from the right-drive bicycle, the hub shell 20 is reversed in direction so that the flywheel mounting cylinder 40 is located at the left side of the left-drive bicycle. Further, the positions of the pawl 32 and the biasing member 33 in each retreat bore 23 are exchanged so that the biasing member 33 is led by the pawl 32 in the driven position.

As illustrated, the hub assembly according to this invention is suitable for use in left-drive and right-drive bicycles. Therefore, manufacturing and storage costs can be reduced, and mounting of the hub assembly to the bicycle is convenient to conduct.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A hub assembly for a bicycle which has a hub axle, comprising:
a hub shell which is adapted to be mounted on and to be rotatable relative to the hub axle about an axis, and which has an inner tubular wall surface that is adapted to be spaced apart from the hub axle so as to define an annular accommodation space therebetween, that extends along the axis, and that terminates at an inner periphery, said inner tubular wall surface having a plurality of retreat bores which are angularly displaced from one another about the axis, which are disposed proximate to said inner periphery, and which respectively extend outwardly and radially, each of said retreat bores including first and second retaining regions opposite to each other in a circumferential direction, and a middle region interposed therebetween;
a spoke-mounting member which extends outwardly and radially from said inner periphery, and which has a plurality of access openings that are angularly displaced from one another around the axis and that extend axially to be communicated with said retreat bores, respectively;
a plurality of pawls, each including
a coupling end which extends into said annular accommodation space,
a pivotable end which is opposite to said coupling end, and which is insertable into one of said first and second retaining regions from a corresponding one of said access openings and which is pivotable relative to said one of said first and second retaining regions so as to permit said coupling end to be moved between a driven position, where said coupling end extends radially into said annular accommodation space, and an idle position, where said coupling end retreats radially into said middle region, and
an intermediate segment which is interposed between said pivotable and coupling ends, and which has urged and trailing lateral sides that are opposite to each other, and that respectively confront the other one of said first and second retaining regions and said annular accommodation space;
a flywheel mounting cylinder which is adapted to be rotatably mounted on the hub axle, and which has a tubular coupling wall that confronts said spoke-mounting member;
an annular drive member rotated with said tubular coupling wall, and having a circumferential surface which confronts said inner tubular wall surface radially, and which has a plurality of cavities angularly displaced from one another about the axis, each of said cavities being configured to extend towards the axis to form first and second engaging walls which are spaced apart from each other in a clockwise or counterclockwise direction about the axis, and which respectively cooperate with said circumferential surface to form first and second force effecting edges such that, when said annular drive member is rotated about the axis, said coupling end is engaged with one of said first and second engaging walls to place said coupling end in the driven position, and such that, when said coupling end is in the idle position, said trailing lateral side is pushed by pressing forces of said first force effecting edges or said second force effecting edges of said cavities to permit disengagement of said coupling end from said one of said first and second engaging walls for retreating said coupling end into said middle region; and
a plurality of biasing members, each of which is disposed in said other one of said first and second retaining regions, and each of which is configured to bias said urged lateral side so as to ensure the engagement of said coupling end with said one of said first and second engaging walls in the driven position,
said first and second retaining regions of each of said retreat bores being configured such that, when said annular drive member is rotated in the clockwise or counterclockwise direction in the driven position, each of said biasing members is trailing behind a corresponding one of said pawls.

2. The hub assembly according to claim 1, wherein each of said biasing members is a leaf spring which includes a bending portion that is retained in said other one of said first and second retaining regions, and first and second biasing end portions that extend from said bending portion towards said middle region, and that are spaced apart from each other in a radial direction relative to the axis so as to enable said second biasing end portion to bias said urged lateral side.

3. The hub assembly according to claim 2, wherein said inner tubular wall surface has a plurality of first barrier portions, each of which is disposed adjacent to said one of said first and second retaining regions and is configured to engage said trailing lateral side proximate to said pivotable end to enable said urged lateral side to counteract against the biasing force of said second biasing end portion so as to ensure the engagement of said coupling end with said one of said first and second engaging walls in the driven position, and a plurality of second barrier portions, each of which is configured to adjust the biasing force of said second biasing end portion.

4. The hub assembly according to claim 1, wherein each of said cavities is of a rectangular shape.

5. The hub assembly according to claim 1, wherein said first and second retaining regions in each of said retreat bores are mirror images of each other.

6. The hub assembly according to claim 1, wherein said trailing lateral side of each of said pawls is disposed to be in slidable contact with said one of said first and second force effecting edges when said coupling end is in the driven position.
